(19) United States
(12) Patent Application Publication
(10) Pub. No.: US 2025/0096347 A1
(43) Pub. Date: Mar. 20, 2025

(54) Vehicle, Method and Arrangement for an Electrochemical Stored Energy Source

(71) Applicant: Bayerische Motoren Werke Aktiengesellschaft, Muenchen (DE)

(72) Inventor: Simon NUERNBERGER, Bad Aibling (DE)

(21) Appl. No.: 18/580,894

(22) PCT Filed: Jun. 29, 2022
(86) PCT No.: PCT/EP2022/067974

§ 371 Date: Jan. 19, 2024

(30) Foreign Application Priority Data
Jul. 22, 2021 (DE) 10 2021 119 070.3

(51) Int. Cl. H01M 10/643; H01M 10/613; H01M 10/615; H01M 10/625; H01M 10/6552; H01M 10/6557; H01M 10/6571; H01M 50/213; H01M 50/244; H01M 50/249

(52) U.S. Cl. CPC H01M 10/643; H01M 10/613; H01M 10/615; H01M 10/625; H01M 10/6552; H01M 10/6557; H01M 10/6571; H01M 50/213; H01M 50/244; H01M 50/249; H01M 2220/20

(57) ABSTRACT

A method, a vehicle and an arrangement for an electrochemical stored energy source are described. The arrangement includes a honeycomb structure having hollow-cylindrical tube shapes and secondary cavities, and electrical cells in the hollow-cylindrical tube shapes. At least some of the secondary cavities are arranged such that each is adjacent to three of the hollow-cylindrical tube shapes, and the each of the secondary cavities has a coolant channel or an active heating apparatus alternating spatially with one another.

### BACKGROUND AND SUMMARY

The present invention relates to a vehicle, to a production method, and to an arrangement for an electrochemical energy store. The present invention relates in particular to a functional group for producing a traction energy store for vehicle that can be electrically driven.

Electrochemical energy stores are currently favored for the electrification of individual passenger transport. The traction energy stores herein are conceived as accumulator packs which have a plurality of electrochemical cells. The electrochemical cells can be of a cylindrical design, for example. The performance of the electrochemical cells, which are usually constructed using lithium-ion technology, is dependent on the temperature. This temperature dependence of the output is very pronounced in particular with cells having a high energy density, manganese-rich cell chemistry, or when using solid electrolytes (all solid state). The lower the cell temperature, the lower the available output. Cooling concepts for cylindrical cells are in most instances of a very complex design, wherein serpentine or meandering cooling plates are provided between the cells. This concept leads to asymmetrical cooling of the cells, in which heat is in most instances discharged only from one side, which causes disadvantages in the operation of cells with comparatively large diameters. A procedure referred to as “plating” can take place on the cold side above all during charging. In the event of a fault, the cellular propagation becomes more difficult to control as the energy density increases. In the event of thermal runaway occurring in a cell, the adjacent cells may likewise be subjected to thermal runaway as a result of the heat build-up. This procedure at times makes its way through the entire traction energy store. As a result of this chain reaction, the entire energy store (at times consisting of several 100 cells) may be damaged. Moreover, the handling of the individual cells and their placement in the vehicle is at times complex because this requires a lot of manual labor. Suitable aids and methods are required for positioning the electrochemical cells and linking them in electrical and thermal terms.

Moreover, it is a currently favored approach to also use the traction energy stores for mechanically stiffening vehicle modules, in particular floor assemblies.

Proceeding from the aforementioned prior art, it is an object of the present disclosure to simplify the use of electrochemical energy cells in traction energy stores, and to improve the thermal management.

The aforementioned object may be achieved according to the disclosure by an arrangement for an electromechanical energy store, in particular a traction energy store. The electrochemical energy store can in particular be based on lithium-ion technology or lithium-ion polymer technology. The arrangement comprises a honeycomb structure which can receive a plurality of electric cells (also referred to as elementary cells). To this end, the honeycomb structure has hollow-cylindrical tubular shapes which have cavities lying parallel to one another. The tubular shapes have convex lateral surfaces, such that secondary cavities are created between a plurality of adjacent hollow-cylindrical tubular shapes. These secondary cavities in turn have concave lateral surfaces and are in particular of an almost triangular design. In this way, the secondary cavities likewise run parallel to the hollow-cylindrical tubular shapes. Electric cells which serve for storing electric energy are disposed in the electric cells. The electrical connectors of the latter can be grouped together on one side or disposed on one of the mutually opposite end faces. At least some of the secondary cavities are arranged adjacent to or directly surrounded by three of the tubular shapes. This arrangement results in particular when two rows of tubular shapes which are disposed rectilinearly beside one another are disposed so as to be mutually offset by half a tubular shape diameter and thus in a “close-packed cylindrical package.” Two hollow-cylindrical tubular shapes of a first row, conjointly with a further hollow-cylindrical shape of the adjacent row, create the secondary cavity. In other words, the lateral surfaces of the hollow-cylindrical tubular shapes form the lateral surfaces of the secondary cavities disposed therebetween. The secondary cavities preferably have in each case, in a spatially alternating manner, one coolant duct or one active heating device. In the case of the close-packed cylindrical package, this means that situated about a hollow-cylindrical tubular shape, for example at 0°, may be a heating device, at 60° a coolant duct, at 120° a further heating device, at 180° a further coolant duct, at 240° a further heating device, and at 300° a further coolant duct. The same can apply in an analogous manner to all hollow-cylindrical tubular shapes of the honeycomb shape (while neglecting peripheral regions). In this way, a simple input and output of heat may be guaranteed in the arrangement, and uniform cooling and heating of the electric cells may be possible, and the construction of an electromechanical energy store is clearly structured as well as reliable and simple in electrical and thermal terms.

The dependent claims show preferred refinements of the invention.

The coolant duct can be connected to an active cooling device. The coolant duct can be provided in the secondary cavity which in particular has a triangular cross section. As described above, the triangular cross section can be adapted concavely to the hollow-cylindrical tubular shapes with a cylindrical shell design. The secondary cavities can in this way per se be designed as coolant ducts, or have the coolant duct running through them. The coolant duct can in particular have connectors (e.g., hose ports, or similar) on both sides so as to fluidically connect a coolant conduit to a heat exchanger and/or a heat pump and/or a cooling apparatus with the periphery (superordinate structure) of the arrangement according to the disclosure. This does not preclude that the coolant duct may also be fluidically connected directly to a further coolant duct (e.g., adjacent coolant duct) so as to be able to perform the input and output of the coolant to and from the superordinate structure only on one end side of the arrangement.

Furthermore preferably, the heating device can be an electric heating device, for example in the form of heating wires in the secondary cavity. This may result in a best possible control capability, and fluid conduits may not be necessary. The heating device can have a heating element which has a heating spiral in an inert isolator, the latter in turn being contained in a casing tube which is adapted to the wall of the secondary cavities. The electrical connectors of the electric heating device can be grouped together on one side, or be disposed on mutually opposite end faces of the respective heating device. The electric heating devices can be inserted and/or cast and/or adhesively bonded in the secondary cavities. In particular, a thermally conducting paste can provide the heat transfer between the electric heating device and the hollow-cylindrical tubular shapes, or electric cells, respectively.

The connection of the superordinate periphery, or of the coolant lines, to the coolant ducts is simplified in that, for example, the coolant ducts at the end side can project or be recessed in relation to the tubular shapes. For example, a coolant line can be pushed over projecting coolant duct ends in the form of ports, while in the case of recessed coolant duct ends the coolant lines can be inserted into the hose sockets shaped in this way. Alternatively, a flat (e.g., sheet metal-type) structure can also be attached to the side proximal to the end face, so as to group together the coolant ducts on one side. In this instance, bores can be disposed at those locations of the flat structure at which the electrical connectors of the electric cells are disposed. A seal or a tubular portion which surrounds the individual bores can ensure the fluidic tightness of the coolant ducts in relation to the electrical connectors.

The honeycomb structure can function as an electrical isolator between the individual electric cells. For this purpose, the honeycomb structure can for example be made of a polymer, or comprise a polymer. A resistance to corrosion in relation to the coolant can also be ensured by the choice of material and manufacture.

In particular, each of the tubular shapes may be surrounded by six secondary cavities, wherein three of the secondary cavities are designed as a heating device, and the other three are designed as a cooling device. Here too, the peripheral regions are not to be included, for which there may be requirements other than those within the regular structure of the arrangement, depending on the specific application and the environment of the application. For example, the peripheral regions can be designed so as to correspond to a cavity in a body of a vehicle, so as to guarantee safe and sustainable positioning of the honeycomb structure in the cavity.

Proposed according to a second aspect of the present disclosure is a method for producing an arrangement as has been proposed in detail above. In a first step, a honeycomb structure may be provided. The honeycomb structure can be produced, for example, as a 3D-printed part and/or as an injection-molded part. Likewise, the honeycomb structure can be produced as an extruded profile. In a second step, electric cells may be introduced or inserted in the tubular shapes of the honeycomb shape. The electric cells can be electrically connected to one another and/or to a higher-level electrical periphery now or at a later point in time. In a further step, electric heating devices are introduced into a first plurality of secondary cavities. The electric heating devices can be designed as heating elements. Switches and/or resistors and/or electric circuits, by way of which energy from the electric cells for heating the electric cells by means of the electric heating devices can be transmitted, can be disposed between the electric heating devices and the electric cells. To this end, temperature sensors can be contained in the arrangement, by way of which a heat a requirement for the electric cells can be determined and corresponding energy can be introduced by way of the electric heating devices. Coolant ducts are then connected to the remaining secondary cavities. It is ensured in this way that the secondary cavities, which are provided for cooling the electric cells, can be purged with a cooling fluid (e.g., water and/or glycol). The aforementioned method steps can be carried out in the sequence mentioned, or in a sequence deviating therefrom. The features, combinations of features and the advantages of the production method according to the invention derived therefrom are derived in an analogous manner from the first-mentioned aspect of the invention so obviously that reference is made to the explanations above in order to avoid repetitions.

To the extent that the arrangement according to the invention is to be used as a traction energy store in a vehicle, in a further method step the on-board wiring system of the vehicle can be connected to the heating devices and/or to the electric cells, or can be made selectively connectable (switchable) thereto. In this way, the vehicle can be driven by electrochemical energy kept available in the arrangement according to the invention.

According to a third aspect of the present disclosure, a vehicle, which has an arrangement according to the first-mentioned aspect of the invention, is correspondingly proposed. The vehicle can be designed, for example, as a passenger motor vehicle, van, commercial motor vehicle, motorcycle, aircraft and/or watercraft. The features, combinations of features and the advantages of the vehicle according to the invention derived therefrom are also are derived in an analogous manner so obviously that reference is made to the explanations above in order to avoid repetitions.

Further details, features and advantages of the invention are derived from the description hereunder and the figures.

### BRIEF DESCRIPTION OF THE DRAWINGS

In the figures:

FIG. 1 shows a schematic illustration of an arrangement of electric cells in the honeycomb grid;

FIG. 2 shows a schematic view from above of the honeycomb structure which can be used according to the disclosure and in which heating devices are introduced into a proportion of the secondary cavities of the honeycomb shape;

FIG. 3 shows the arrangement illustrated in FIG. 2, in which the remaining secondary cavities are filled with a cooling fluid;

FIG. 4 shows a perspective illustration of a portion of an arrangement according to the disclosure, wherein a secondary cavity is fluidically connected to a higher-level structure; and

FIG. 5 shows a flow chart for visualizing steps of an exemplary embodiment of a method according to the disclosure for producing an arrangement according to the disclosure for an electrochemical energy store.

### DETAILED DESCRIPTION OF THE DRAWINGS

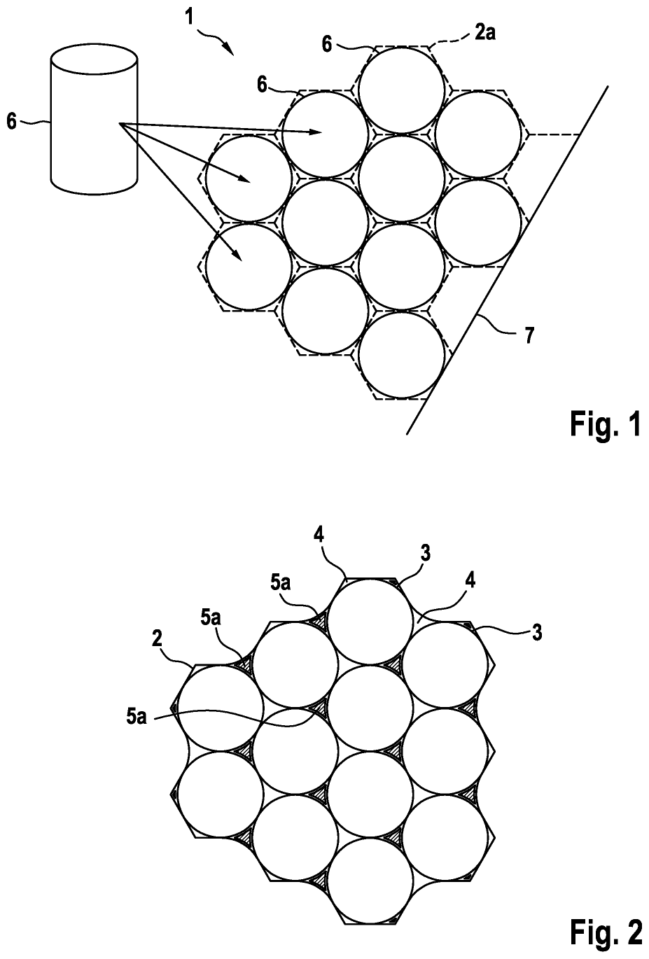

FIG. 1 shows a view from above of a plurality of electric cells 6 which can be contained in an arrangement 1 according to the disclosure. The electric cells 6 are disposed in a honeycomb structure 2a which is illustrated only for visualizing the mutual geometric arrangement of the electric cells 6. For this purpose, an individual electric cell 6 is illustrated in a perspective view. Moreover, a housing wall 7 which is adapted to the higher-level structure (e.g., a floor assembly of a vehicle), is illustrated with solid lines. The arrangement 1 can be adapted to the cavity/the installation space in a vehicle (not illustrated) via the housing wall 7 without play. A thermal exchange with the environment (e.g., for discharging heat) can take place in this way, and the arrangement 1 according to the disclosure can contribute toward the stability of the surrounding structure. Moreover, creaking and rattling noises are avoided.

FIG. 2 shows a view from above of a honeycomb shape 2 which can be used according to the disclosure and has hollow-cylindrical tubular shapes 3 disposed in a close-packed cylindrical package. Secondary cavities, of which half are already filled with active heating devices 5a, are provided between the hollow-cylindrical tubular shapes 3. The other half of the secondary cavities 4 is still empty and provided for the discharge of heat.

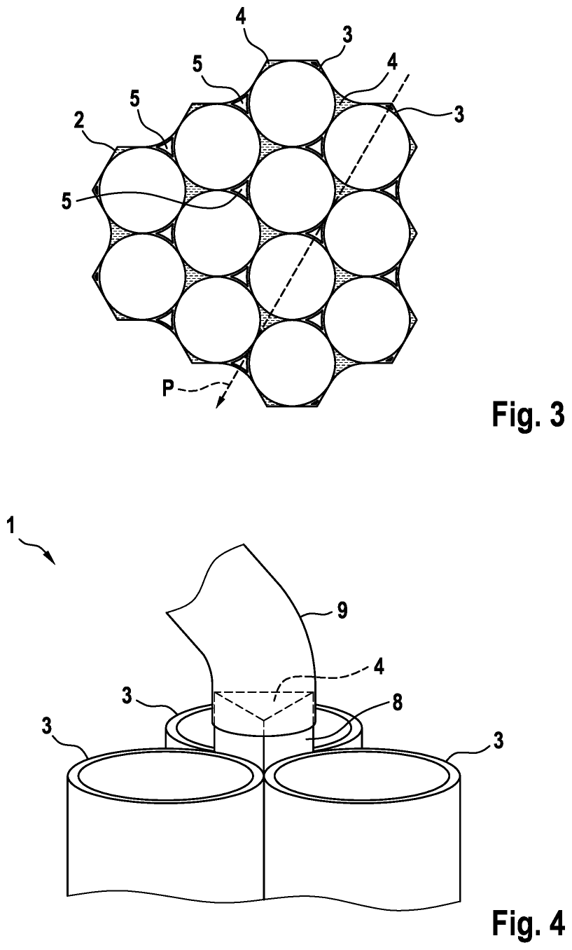

FIG. 3 shows the arrangement illustrated in FIG. 2 after the secondary cavities 4 have been filled with a coolant which may be composed of water and glycol, for example. An arrow P indicates a preferred crash direction for the arrangement illustrated. By virtue of the relative arrangement of the hollow-cylindrical tubular shapes 3 and the electric cells (not yet introduced), forces acting in the direction of the arrow P can effect widening of the arrangement in the transverse direction and thus dissipate a maximum of deformation energy to the surrounding structure.

FIG. 4 shows a perspective illustration in the form of a detailed view in which a secondary cavity 4 at the end side is designed to protrude in relation to the hollow-cylindrical tubular shapes 3. This part of the secondary cavity 4 serves as a connector for a hose 9 as a coolant duct, by way of which cold fluid can be supplied, or heated fluid can discharge excess heat.

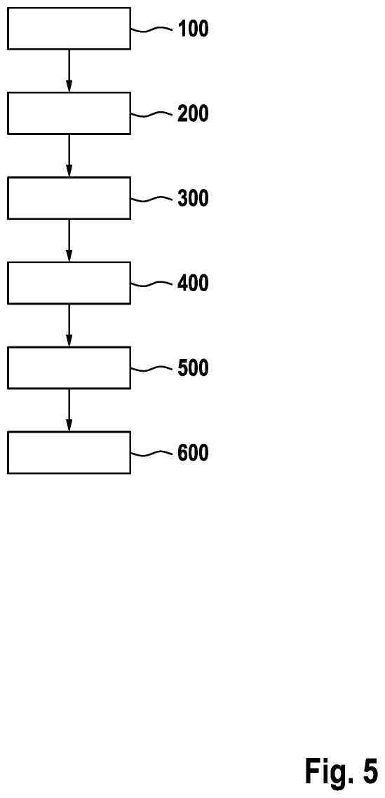

FIG. 5 shows steps of an exemplary embodiment of a production method according to the disclosure for the arrangement described above. In a first step 100, a honeycomb structure which defines the honeycomb shape for the arrangement is provided. The honeycomb structure can be made, milled, cast or injection-molded from a polymer. In step 200, electric cells are introduced into the tubular shapes of the honeycomb structure. In step 300, electric heating devices are introduced into a first half of the plurality of secondary cavities. In the process, no secondary cavities which are directly adjacent to one another are filled with heating devices, so as to be able to provide an alternating arrangement between heating devices and cooling ducts. In step 400, cooling conduits are connected to the remaining secondary cavities. These cooling conduits can supply cooled coolant from the higher-level structure, or ensure the discharge of process heat by means of a heated coolant fluid. In step 500, the electrical contacting of the heating devices is subsequently performed. These heating devices can be connected to the electric cells in step 500. In particular, each one of the electric heating devices can be connected to an electric cell adjacent thereto. A switch, or an electric circuit, between the respective heating device and the respective electric cell can be provided here. In this way, each one of the electric cells can itself generate the heat required by the electric cell for a suitable operating point. The electric circuit here can have a temperature sensor which is provided only for the heating device in consideration and the electric cell assigned thereto. In this way, decentralized electric heating can be provided if required, without higher-level control apparatuses having to be involved for this purpose. In step 600, the electric cells are electrically connected to an onboard wiring system of the vehicle. In the process, the electric heating devices and/or the switching devices/circuits thereof can also as described above be connected to the onboard wiring system (energy wiring system and/or information wiring system) of the vehicle.

The arrangement thus produced can subsequently be inserted into a vehicle, unless this has already taken place at an earlier point in time.

### LIST OF REFERENCE SIGNS

1 Arrangement
2 Honeycomb structure
3 Hollow-cylindrical tubular shape
4, 5 Secondary cavities
5a Electric heating device
6 Electric cell
7 Housing wall of the honeycomb structure 2
8 Port
9 Hose
100-600 Method steps
P Arrow

1-10. (canceled)

11. An arrangement for an electrochemical energy store, the arrangement comprising:
a honeycomb structure having:
hollow-cylindrical tubular shapes having cavities lying parallel to one another; and
secondary cavities disposed between the hollow-cylindrical tubular shapes; and
electric cells positioned in the hollow-cylindrical tubular shapes;
wherein
at least some of the secondary cavities are arranged such that each is adjacent to three of the hollow-cylindrical tubular shapes, and
each of the secondary cavities has, in a spatially alternating manner, a coolant duct or an active heating device.

12. The arrangement according to claim 11, wherein the coolant duct is connected to an active cooling device.

13. The arrangement according to claim 11, wherein the heating device is an electric heating device.

14. The arrangement according to claim 11, wherein the coolant duct at an end side projects in relation to the hollow-cylindrical tubular shapes or is recessed in relation to the hollow-cylindrical tubular shapes.

15. The arrangement according to claim 11, wherein the honeycomb structure comprises an electrical isolator and/or is made of a polymer.

16. The arrangement according to claim 11, wherein each of the hollow-cylindrical tubular shapes is surrounded by six of the secondary cavities.

17. A method for producing an arrangement according to claim 11, the method comprising:
providing the honeycomb structure;
introducing the electric cells into the hollow-cylindrical tubular shapes;
introducing electric heating devices into a first plurality of the secondary cavities; and
connecting coolant conduits to a remaining plurality of the secondary cavities.

18. The method according to claim 17, further comprising:
connecting the electric heating devices.

19. The method according to claim 17, further comprising:
electrically connecting the electric cells to an onboard wiring system of a vehicle.

20. A vehicle comprising the arrangement according to claim 11.
